(19) United States
(12) Patent Application Publication
(10) Pub. No.: US 2008/0163797 A1
(43) Pub. Date: Jul. 10, 2008

(54) Pore reducing technology for concrete

(76) Inventor: Paul W. Brown, State College, PA (US)

Correspondence Address: ECKERT SEAMANS CHERIN & MELLOTT, 600 GRANT STREET, 44TH FLOOR, PITTSBURGH, PA, 15219, US

(21) Appl. No.: 11/452,516

(22) Filed: Jun. 14, 2006

Related U.S. Application Data
(60) Provisional application No. 60/693,393, filed on Jun. 23, 2005.

(51) Int. Cl. C04B 7/00

(52) U.S. Cl. 106/806

(57) ABSTRACT

The present invention provides methods and compounds for reducing porosity in concrete using alkoxides. In a preferred embodiment, an Si-containing alkoxide, e.g., Si(OC₂H₅)₄ (TEOS) or Si(OCH₃)₄, may be introduced to concrete where it penetrates the pore spaces. The Si-containing alkoxide undergoes hydrolysis and polymerization reactions to form silica gel, which reduces the volume of pore spaces. In addition, hydrous silica formed during the polymerization step may react with calcium hydroxide to form CSH, which may also reduce the volume of pore spaces. The calcium hydroxide may be locally available or it may be provided by introducing a Ca-containing alkoxide solution, which forms calcium hydroxide through a hydrolysis reaction.

### CROSS-REFERENCE TO RELATED APPLICATION

This application claims the benefit of U.S. Provisional Patent Application Ser. No. 60/693,393 filed Jun. 23, 2005, entitled: “PORE REDUCING TECHNOLOGY FOR CONCRETE”.

### FIELD OF THE INVENTION

The present invention relates to methods and compounds for reducing porosity in crete using alkoxides, and more particularly relates to the use of an Si-containing alkoxide to form silica gel, or the use of an Si-containing alkoxide coupled with the use of a Ca-containing alkoxide to form calcium silicate hydrate.

### BACKGROUND INFORMATION

Concrete porosity refers to the pore spaces in concrete that are formed by air bubbles or by the spaces that remain occupied with liquid water after the concrete has hardened. These pore spaces are located throughout the concrete, including those areas that are deep or non-surficial. Traditionally, the porosity of concrete has been reduced through the use of epoxies, organic penetrating sealers, and alkali silicates such as sodium and potassium silicates. However, reports on the effectiveness of these techniques are mixed. Traditional methods tend to block pores spaces at or near the surface of the concrete. When pore spaces are blocked near the surface of the concrete, moisture may accumulate in regions behind the filled pores. The physical properties of these filled regions may differ, resulting in delamination of certain areas. Furthermore, blocking of surficial pore space is undesirable if salt has accumulated at or near the concrete surface (either the top or bottom surface) because osmotic forces can produce elevated local pressures which can lead to failure of the sealed region. Thus, it is preferable to penetrate and reduce porosity below the salt accumulated region.

### SUMMARY OF THE INVENTION

The present invention provides methods and compounds for reducing porosity in concrete using alkoxides, particularly porosity that is located in non-surficial regions or deep within the concrete. In a preferred embodiment, Si- and Ca-containing alkoxides may be used to produce any of the following, individually or in combination: silica gel, calcium silicate hydrate (CSH)+silica gel, CSH of any Ca/Si ratio, CSH+calcium hydroxide, and calcium hydroxide. An Si-containing alkoxide, e.g., Si(OC₂H₅)₄ (TEOS) or Si(OCH)₃)₄, may be introduced to concrete where it penetrates the pore spaces. The Si-containing alkoxide undergoes hydrolysis and polymerization reactions to form silica gel, which reduces the volume of the pore spaces. In addition, hydrous silica formed during the polymerization step may react with calcium hydroxide to form CSH, which may also reduce the volume of the pore spaces. The calcium hydroxide may be locally available or it may be provided by introducing a Ca-containing alkoxide solution, which forms calcium hydroxide through a hydrolysis reaction.

An aspect of the present invention is to provide a method of reducing porosity in concrete, the method comprising introducing an Si-containing alkoxide to concrete, wherein the Si-containing alkoxide reacts with water to form silica gel, and the silica gel reduces the volume of the pore spaces in the concrete.

An object of the present invention is to provide a method of reducing porosity in concrete that utilizes alkoxides.

Another object of the present invention is to provide a method of reducing porosity in concrete that facilitates the infiltration of pore spaces.

A further object of the present invention is to provide a method of reducing porosity in concrete that is capable of reaching non-surficial or deep pore spaces within a concrete slab.

Another object of the present invention is to provide a method of reducing porosity in concrete that employs sol gel processes (hydrolysis and polymerization).

A further object of the present invention is to provide a method of reducing porosity in concrete that employs calcium silicate hydrate (CSH).

Another object of the present invention is to provide a method of reducing porosity in concrete that can be modified by introducing acids, bases, and/or corrosion inhibitors.

These and other objects of the present invention will become more readily apparent from the following detailed description and appended claims.

### TABLES

Table 1 presents RCPT test results.

Table 2 presents the results of treatment with ethyl silicate Silbond 40.

### DETAILED DESCRIPTION OF THE PREFERRED EMBODIMENTS

The present invention provides methods and compounds for reducing porosity in concrete using alkoxides, particularly porosity that is located in non-surficial regions or deep within the concrete. In a preferred embodiment, Si- and Ca-containing alkoxides may be used to produce any of the following, individually or in combination: silica gel, calcium silicate hydrate (CSH)+silica gel, CSH of any Ca/Si ratio, CSH+calcium hydroxide, and calcium hydroxide. An Si-containing alkoxide, e.g., Si(OC₂H₅)₄ (TEOS) or Si(OCH₃)₄, may be introduced to concrete where it penetrates the pore spaces. The Si-containing alkoxide undergoes hydrolysis and polymerization reactions to form silica gel, which reduces the volume of the pore spaces. In addition, hydrous silica formed during the polymerization step may react with calcium hydroxide to form CSH, which may also reduce the volume of the pore spaces. The calcium hydroxide may be locally available or it may be provided by introducing a Ca-containing alkoxide solution, which forms calcium hydroxide through a hydrolysis reaction.

An alkoxide is formed when the proton associated with an alcohol group is replaced by another cation. Examples of alkoxides containing cations of various valences are as follows:
Monovalent: NaOCH₃;
Divalent: Ca(OC₂H₅)₂;
Trivalent: B(OCH₃)₃, P(OC₃H₇)₃, Y(OC₂H₅)₃, Al(OC₃H₇)₃, Al(OC₄H₉)₃;
Tetravalent: Si(OCH₃)₄, Si(OC₂H₅)₄, Ti(OC₂H₅)₄, Ti(OC₃H₇)₄, Ti(OC₄H₉)₄, Ti(OC₅H₇)₄, Ge(OC₂H₅)₄, Zr(OC₂H₅)₄, Zr(OC₃H₇)₄; and
Pentavalent: Nb(OC₂H₅)₅.
   The nature of the alcohol groups can vary, and the alkoxides may be methoxides, ethoxides, propoxides, butoxides, etc. While the description contained herein primarily refers to the use of Si- and Ca-containing alkoxides, it is understood that the invention also contemplates the use of alkoxides that are not based on silicon or calcium. In particular, the invention may use any alkoxide which contains a divalent cation (e.g., barium alkoxide) and any alkoxide which contains a tetravalent cation (e.g., germanium alkoxide).

In a preferred embodiment, the Si-containing alkoxide may comprise Si(OC₂H₅)₄, which is also known as TEOS, tetraethyloxysilane, and ethyl silicate. The invention may also utilize ethyl polysilicate, which is partially hydrolyzed TEOS. Depending on its degree of hydrolysis, ethyl polysilicate may contain various proportions of silica. These typically range from about 28 percent (unhydrolyzed) to 45 percent silica. However, lower proportions can be established by dilution with water or polar non-aqueous solvents such as ethanol or methanol. At room temperature TEOS and ethyl polysilicates exist as a low viscosity liquid, which makes them suitable for penetrating or infiltrating the pore spaces in concrete. Once exposed to water, TEOS hydrolyzes to form hydrous silica and ethanol. The water may be present “in situ” within or surrounding the concrete; alternatively, a source of water may be introduced to the concrete.

The TEOS undergoes two reactions (hydrolysis and polymerization) that occur simultaneously. The first reaction involves the systematic hydrolysis of the alcohol groups to form hydroxyl groups:

—Si—OC₂H₅+H₂O→—Si—OH+C₂H₅OH (1)

The second reaction is a condensation reaction in which the hydrous silica undergoes polymerization to form silica gel:

—Si—OH+HO—Si—→—Si—O—Si—+H₂O (2)

The water consumed in hydrolysis is re-released in the polymerization reaction. The water either remains in the pore spaces or evaporates.

The hydrous silica formed (SiO₂·H₂O) is a solid material that reduces the volume of pore spaces in the concrete to reduce the concrete's porosity. Because the Si-containing alkoxide is a low viscosity liquid, it infiltrates deeper within the concrete pore spaces than would a traditional pore blocking agent (e.g., Na or K silicate). Thus, the silica gel that forms is capable of reducing pore volumes that are located in non-surficial or deep regions within the concrete, in contrast to traditional pore blocking technology. However, the present invention also contemplates the reduction of pore space volume in surficial regions of the concrete.

The nanostructure of the hydrous silica formed in equation (1) can be altered by adjusting the pH of the local conditions within the concrete pore space. For example, the viscosity of an Si-containing solution during hydrolysis and condensation reactions may be adjusted by adding small amounts of acid or base. An acid may be introduced to the concrete to slow hydrolysis and speed polymerization, while a base may be introduced to speed hydrolysis and slow polymerization. Although the pore solutions in normal concrete are generally highly basic, pores in deteriorated concrete may be filled with solutions at near neutral pH. Thus, it is anticipated that either acid or base catalyzed hydrolysis and polymerization of TEOS and like Si-containing alkoxides could be carried out. Suitable catalysts may include, but are not limited to, alkali silicate solutions which are basic, or certain salts such as NaH₂PO₄ which are made by partially neutralizing acids and can produce acidic solutions. Mineral and organic acids may be utilized, including but not limited to HCl, H₂SO₄, HNO₃, and oxalic acid. An example of a suitable base is NaOH, although the invention contemplates the use of numerous other bases.

In an alternative embodiment, partially hydrolyzed TEOS may be used as the Si-containing alkoxide. An example of partially hydrolyzed TEOS is Silbond 40 which contains about 40 weight percent silicon. The silicon content of non-hydrolyzed TEOS in comparison is about 28 weight percent. Partial hydrolysis reduces volatility of the Si-containing alkoxide thereby reducing its combustion potential.

Depending on the condition of the concrete, calcium hydroxide may or may not be locally available in the concrete. If calcium hydroxide is locally available, the hydrous silica formed in equation (1) may react with the calcium hydroxide in a pozzolanic reaction to form calcium silicate hydrate (CSH) as follows:

1.7Ca(OH)₂+SiO₂+3H₂O→1.7CaO·SiO₂·4H₂O (3)

Because CSH is the primary binder in Portland cement concretes, the compound will reduce the volume of pore spaces in concrete, thereby assisting in reducing porosity.

If calcium hydroxide is not locally available, the hydrous silica can be expected to persist unless an external source of calcium hydroxide is introduced to the concrete. In a preferred embodiment, a Ca-containing alkoxide such as Ca(OC₂H₅)₂ may be introduced to the concrete to form calcium hydroxide according to the following reaction:

Ca(OC₂H₅)₂+2H₂O→Ca(OH)₂+2HOC₂H₅ (4)

The calcium hydroxide produced will react with hydrous silica to form CSH. The Ca-containing alkoxide may be intermixed with the Si-containing alkoxide for introduction to the concrete.

Alternatively, the calcium hydroxide may be provided as a fine solid in an emulsion with water. After the water-Ca(OH)₂ emulsion is introduced to the concrete, calcium hydroxide will begin to precipitate and react with hydrous silica to form CSH. The water-Ca(OH)₂ emulsion may be particularly effective in applications where the emulsion is sprayed to seal the top of a concrete slab.

The ratio of Ca-to-Si present in the CSH may vary depending on the proportion of reactants. The Ca-to-Si ratio typically ranges from about 0.83 to about 1.7. A Ca-to-Si ratio of 0.83 corresponds to the CSH composition that co-exists with an excess of reactive silica. A Ca-to-Si ratio of 1.7 corresponds to the CSH composition that co-exists with calcium hydroxide.

The Si- and Ca-containing alkoxides of the present invention are capable of infiltrating pore spaces that are located in non-surficial or deep regions within the concrete. If salt has accumulated at the top or bottom surface of a concrete slab, the alkoxides may be capable of penetrating beyond the salt accumulation. The Si- and Ca-containing alkoxides may be applied using any suitable methodology that encourages the alkoxides to infiltrate the concrete pore spaces. In one embodiment, alkoxide solutions can be puddled onto concrete surfaces and allowed to soak in. After the surfaces are soaked with alkoxides, they may be misted with water to facilitate hydrolysis reactions. To facilitate the infiltration of alkoxides into pore spaces, capillary breaks may be introduced into the concrete. These breaks are similar to the capillary porosity that occurs following continued hydration of Portland cement.

On vertical or upright surfaces, the alkoxides may be applied by wrapping the surface with a textile, covering the surface of the textile with an impervious membrane, introducing the solutions to the textile, and allowing the solutions to soak in. However, it may be more convenient to introduce the alkoxides using pressure application. In such an application, the solutions would be forced into the concrete porosity under an applied pressure.

Whereas particular embodiments of this invention have been described above for purposes of illustration, it will be evident to those skilled in the art that numerous variations of the details of the present invention may be made without departing from the invention as defined in the appended claims.

### EXAMPLES

In the following examples, concrete cores were extracted from the slabs of residential structures. The cores were nominally 4 inches in diameter. The sawn surfaces of the cores were coated with an epoxy (e.g. Sewer Guard HBS 100 epoxy liner) to ensure that ethyl silicate could only enter the concrete from the top surface and that it could not exude out from the sides. The coated cores were left for 24 hours for the epoxy to cure and then sliced into 2″ thick sections. These sections were used for treatment with ethyl silicate (Silbond-40).

### Example 1

Pieces of PVC tubing (approximately 3″ diameter, 4″ height) were glued with a silicon-based glue (RTV silicon adhesive sealant) to the top surfaces of the core sections. This produced a PVC “cup” with a concrete base. Forming cups in this manner permitted the ethyl silicate to form a reservoir above the top surface of each sample. The 2″ core sections were used as is with no attempt to dry them or condition them in a controlled humidity environment. The glue was left to cure for 24 hours and the outside interface between the core and the tube was coated with an epoxy (same as the one used to coat the original cores). After an additional 24 hours, the samples with the glued PVC were pre-weighted and known volumes of ethyl silicate (100 ml) were poured into the PVC tubing. The ethyl silicate reservoir was covered to minimize any evaporation of the ethyl silicate. The samples were checked periodically and after periods ranging from 48 to 96 hours sample weight gains were measured. Typically the weight gain after 48 hours ranged from 20 to 40 grams indicating that these amounts of ethyl silicate had entered the pore structures of the concrete samples.

In some instances an organic dye was added to the ethyl silicate. The dye selected was soluble in ethyl silicate but not soluble in water. The depth of color change (to yellow) permitted visual establishment of the depth of penetration. After 48 hours the samples were transversely fractured and it was established that the ethyl silicate had penetrated throughout the whole sample. In some instances sufficient ethyl silicate had passed through the samples to form puddles below the samples. This indicated that complete penetration of 2 inches of concrete could be achieved within 48 hours.

In other experiments, samples whose sides were not sealed were immersed in ethyl silicate to a depth of 1 inch. These experiments indicated the same extent/amount of penetration.

### Example 2

The RCPT test is used in assessing the permeability of concrete. It is a Standardized method and is described in ASTM C1202-97. The RCPT test was used to assess the effects of ethyl silicate impregnation on the reduction of permeability. One set of untreated samples was used as a control, and 2″ pieces were treated as described above. In some cases the control and the treated samples were taken from the same core.

It is understood that basic aqueous solutions can be used to accelerate hydrolysis/condensation reactions. Unhydrolyzed ethyl silicate can be sealed within the concrete by treating the immediate concrete surface with a basic solution. After penetration the samples were treated with NH₄OH or Ca(OH)₂.

Table 1 compares the total current passed through the samples for various periods of time before and after ethyl silicate penetration. The data reveal the total current passed to be nominally reduced by a factor of 10 as a result of ethyl silicate penetration.

### Example 3

Table 2 summarizes the results of the ethyl silicate/Silbond 40 (ES40) treatments when ethyl silicate was either ponded on top of a concrete sample or when a concrete sample was placed in a pool of ethyl silicate. The extents of uptake were established by determining the gains in sample weight over time. Typically the porosities of these samples will be approximately 15 percent, the gains in weight illustrate that the extent of this porosity can be reduced by about one-third. These results also show that the bulk of the uptake may occur during the first day or may occur more uniformly over four days. Further, the results for sample 3614652A show that liquid can be drawn up into the concrete when ethyl silicate is placed in contact with the bottom of the concrete. The samples were treated further either with a Ca(OH)₂ suspension or NH₄OH. Samples 36X and 83A were treated with NH₄OH and were left unsealed; the weight losses due to evaporation were constantly monitored.

It is understood that the present invention provides methods and compounds for reducing porosity in concrete using alkoxides. The porosity may be located near the surface of the concrete, but is preferably located in non-surficial or deep areas within the concrete. In a preferred embodiment, an Si-containing alkoxide, e.g., Si(OC₂H₅)₄ (TEOS) or Si(OCH₃)₄, may be introduced to concrete where it penetrates the pore spaces. The Si-containing alkoxide undergoes hydrolysis and polymerization reactions to form silica gel, which reduces the volume of pore spaces. In addition, hydrous silica formed during the polymerization step may react with calcium hydroxide to form CSH, which may also reduce the volume of pore spaces. The calcium hydroxide may be locally available or it may be provided by introducing a Ca-containing alkoxide solution, which forms calcium hydroxide through a hydrolysis reaction.

Whereas particular embodiments of this invention have been described above for purposes of illustration, it will be evident to those skilled in the art that numerous variations of the details of the present invention may be made without departing from the invention as defined in the appended claims.

TABLE 1

| | RCPT | | |
|---|---|---|---|
| | run time | Total current | |
| Sample # | (h:mm) | passed (mA) | Sample condition |
| 3612356 | 4:50 | 230.6 | Untreated |
| 3612356T | 6:00 | 31.1 | Treated with ES40 and NH₄OH |
| 3614139 | 6:00 | 178.4 | Untreated |
| 3614139 NaOH | 6:00 | 15.7 | Treated with ES40 and NaOH |
| 3613299 U1 | 6:00 | 196.8 | Untreated |
| 3613296 U1 | 3:25 | 248.0 | Untreated |
| 3612373 U1 | 6:00 | 194.7 | Untreated |
| 3614646A | 6:00 | 196.3 | Untreated |
| 3614661A | 3:05 | 247.6 | Untreated |
| 3614638A | 6:00 | 47.5 | Treated with ES40 and Ca(OH)₂ |
| 3614654B | 6:00 | 2.0 | Treated with ES40 and Ca(OH)₂ |
| 3614661B | 6:00 | 21.2 | Treated with ES40 and Ca(OH)₂ |
| 3614661C | 6:00 | 13.8 | Treated with ES40 and Ca(OH)₂ |

TABLE 2

| | | | Gains in weight (g) or ml taken up | | | | |
|---|---|---|---|---|---|---|---|
| | | ES40 | Uptake | Uptake | Uptake | Uptake | |
| | sample | (ml) | after 1 | after 2 | after 3 | after 4 | |
| sample | weight, g | added | day | days | days | days, g | Observations |
| 3614636A | 795.4 | 60-70 | | | | 42 | wet at bottom |
| 3614638A | 787.9 | 60-70 | | | | 38 | |
| 3614652A | 801.7 | ~90 | 24 g | 28.9 g | 30.9 g | 32 | sample |
| | | | | | | | treated from |
| | | | | | | | bottom, wet |
| | | | | | | | on the top |
| 3614654A | 798.7 | 60-70 | | | | 44 | very wet |
| | | | | | | | bottom |
| 3614658B | 786.5 | 60-70 | | | | 40 | |
| 3614661B | 772.1 | 60-70 | | | | 23 | |
| 3614661C | 768.4 | 60-70 | | | | 27 | |
| 3614669B | 802.1 | 60-70 | | | | 41 | slightly wet |
| | | | | | | | bottom |
| 3614636X | 642.4 | 100 | 5 ml | 10 ml | 15 ml | 22 | wet at bottom |
| 3614883A | 777.8 | 100 | 12.5 ml | 17.5 ml | 20 ml | 25 | wet at bottom |

What is claimed is:

1. A method of reducing porosity in concrete, the method comprising introducing an Si-containing alkoxide to concrete, wherein the Si-containing alkoxide reacts with water to form silica gel, and the silica gel reduces pore space volume in the concrete.

2. The method of claim 1, wherein the Si-containing alkoxide is TEOS.

3. The method of claim 1, wherein the Si-containing alkoxide is partially hydrolyzed TEOS.

4. The method of claim 1, wherein the water is present in the concrete in situ.

5. The method of claim 1, further comprising introducing water to the concrete.

6. The method of claim 1, wherein calcium hydroxide present in the concrete reacts with the silica gel to form calcium silicate hydrate that reduces pore space volume in the concrete.

7. The method of claim 6, wherein the calcium silicate hydrate has a ratio of calcium to silicate ranging from about 0.83 to 1.7.

8. The method of claim 1, further comprising introducing a Ca-containing alkoxide to the concrete, wherein the Ca-containing alkoxide undergoes hydrolysis to form calcium hydroxide.

9. The method of claim 8, wherein the calcium hydroxide reacts with the silica gel to form calcium silicate hydrate that reduces pore space volume in the concrete.

10. The method of claim 9, wherein the calcium silicate hydrate has a ratio of calcium to silicate ranging from about 0.83 to 1.7.

11. The method of claim 1, further comprising introducing calcium hydroxide as a fine solid in a water-Ca(OH)₂ emulsion, wherein the calcium hydroxide reacts with the silica gel to form calcium silicate hydrate that reduces pore space volume in the concrete.

12. The method of claim 11, wherein the calcium silicate hydrate has a ratio of calcium to silicate ranging from about 0.83 to 1.7.

13. The method of claim 1, further comprising introducing an acid to alter speed of hydrolysis and polymerization.

14. The method of claim 1, further comprising introducing a base to alter speed of hydrolysis and polymerization.

15. The method of claim 1, wherein the Si-containing alkoxide can penetrate past accumulated salt in the pore spaces.

16. The method of claim 1, wherein the Si-containing alkoxide is introduced in a solution that is puddled on the concrete.

17. The method of claim 1, wherein the Si-containing alkoxide is introduced by soaking a textile with the Si-containing alkoxide and applying the textile to the concrete.

18. The method of claim 1, wherein the Si-containing alkoxide is introduced by pressure application.

19. The method of claim 1, wherein the Si-containing alkoxide is introduced by spraying.

20. The method of claim 1, wherein the Si-containing alkoxide is introduced as a TEOS-Ca(OH)₂-water grout.

21. The method of claim 1, further comprising introducing capillary breaks in the concrete to facilitate infiltration of the Si-containing alkoxide in the pore spaces.

22. The method of claim 1, wherein the porosity is located in non-surficial regions of the concrete.

23. The method of claim 1, wherein the porosity is located in surficial regions of the concrete.
